(19) United States
(12) Patent Application Publication
(10) Pub. No.: US 2013/0171035 A1
(43) Pub. Date: Jul. 4, 2013

(54) FULLY INSULATED EXHAUST TREATMENT DEVICE

(71) Applicant: Tenneco Automotive Operating Company Inc., Lake Forest, IL (US)

(72) Inventors: Megan Wikaryasz, Ypsilanti, MI (US); Rick Thompson, Jonesville, MI (US)

(73) Assignee: TENNECO AUTOMOTIVE OPERATING COMPANY INC., Lake Forest, IL (US)

(21) Appl. No.: 13/732,587

(22) Filed: Jan. 2, 2013

Related U.S. Application Data
(60) Provisional application No. 61/582,929, filed on Jan. 4, 2012.

(51) Int. Cl. B01D 53/94

(52) U.S. Cl. CPC B01D 53/94
USPC 422/170; 55/495; 55/418; 55/385.7; 55/419; 422/168; 422/169

(57) ABSTRACT

An exhaust treatment device includes an insulation material positioned between an inner shell and an outer shell. An inlet tube has an end in communication with a cavity defined by the inner shell. A substrate for treating engine exhaust is positioned within the inner shell. A cast metal mounting ring is positioned between the inner and outer shells and includes a mounting provision for receipt of a fastener.

### CROSS-REFERENCE TO RELATED APPLICATIONS

The present application claims priority to U.S. Provisional Application Ser. No. 61/582,929 filed Jan. 4, 2012, the disclosure of which is hereby incorporated by reference in its entirety.

### FIELD

The present disclosure relates to an exhaust treatment device for reducing undesirable emissions from an internal combustion engine.

### BACKGROUND

This section provides background information related to the present disclosure which is not necessarily prior art.

One known exhaust treatment device includes an inlet end formed as a casting that is subsequently coupled to a sheet metal housing. The casting includes a mounting provision for the exhaust treatment device. Unfortunately, as the entire inlet assembly is formed from a cast component, heat is transferred readily from the interior of the exhaust treatment device to an exterior surface of the cast inlet assembly. Accordingly, it may be beneficial to provide an improved exhaust treatment device having sufficient thermal shielding.

### SUMMARY

This section provides a general summary of the disclosure, and is not a comprehensive disclosure of its full scope or all of its features.

The present disclosure provides an exhaust treatment device, including an inner shell; an outer shell; and an insulation material positioned between the inner shell and the outer shell. The exhaust treatment device also includes an inlet assembly and an outlet assembly that are axially aligned, and wherein the inlet assembly and the outlet assembly include a portion of the insulation material positioned between the inner shell and the outer shell. The exhaust treatment device also includes a substrate for treating engine exhaust positioned within the inner shell; and a metal mounting ring positioned between the inner and outer shells, the ring including a mounting provision for receipt of a fastener.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary exhaust treatment device according to a principle of the present disclosure;

FIG. 2 is a cross-sectional view taken through the exhaust treatment device depicted in FIG. 1;

FIG. 2A is an expanded cross-sectional view of a portion of a mounting ring illustrated in FIG. 2; and

FIG. 3 is a perspective view of a cast mounting ring.

Corresponding reference numerals indicate corresponding parts throughout the several views of the drawings.

### DETAILED DESCRIPTION

Example embodiments will now be described more fully with reference to the accompanying drawings.

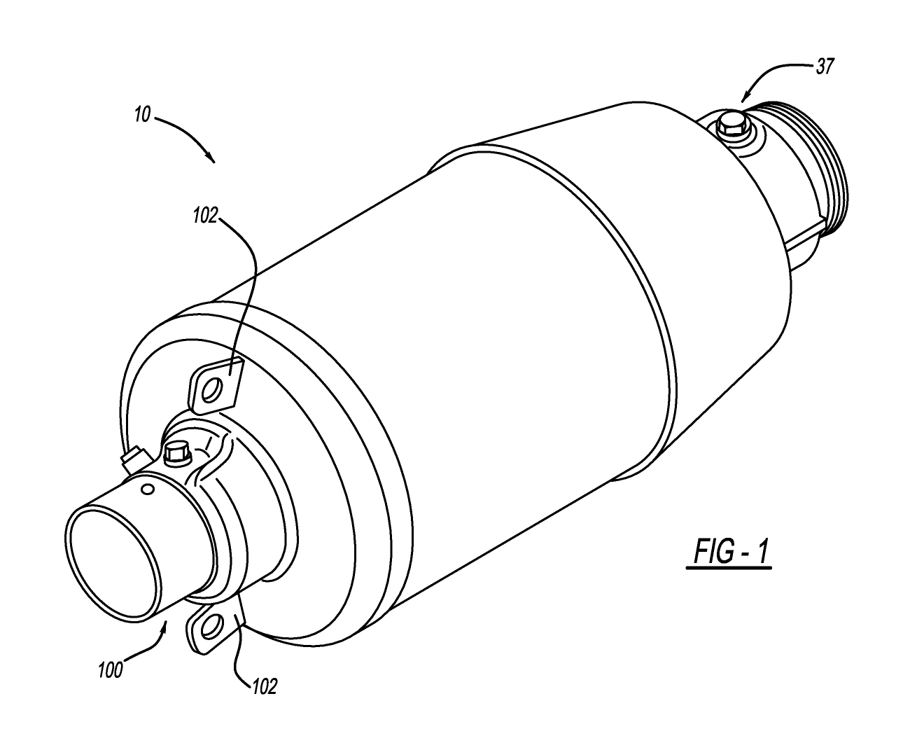

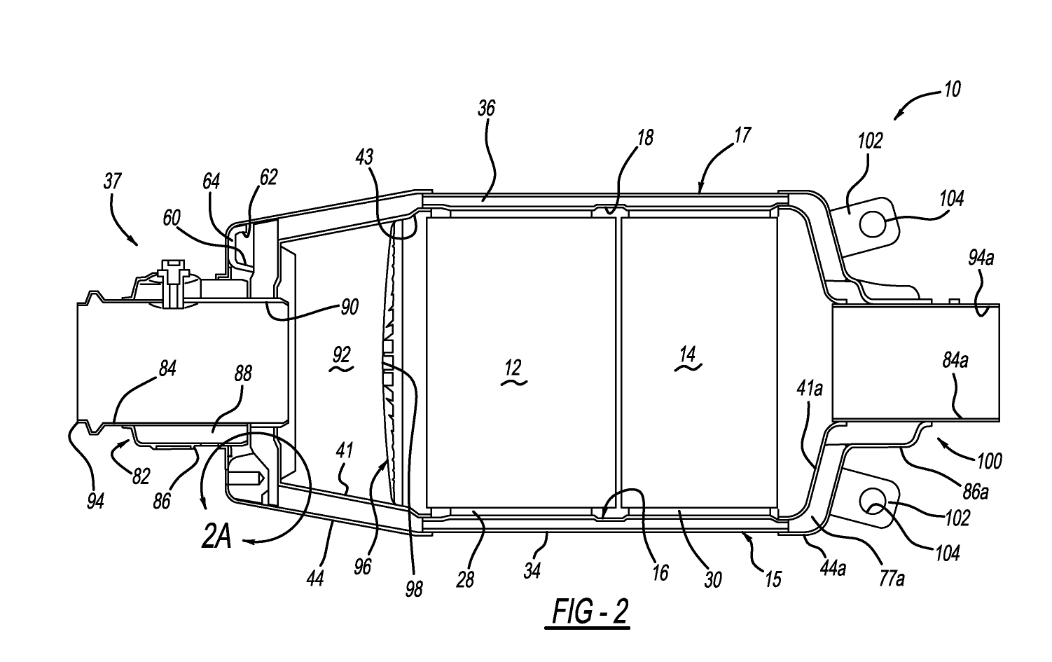

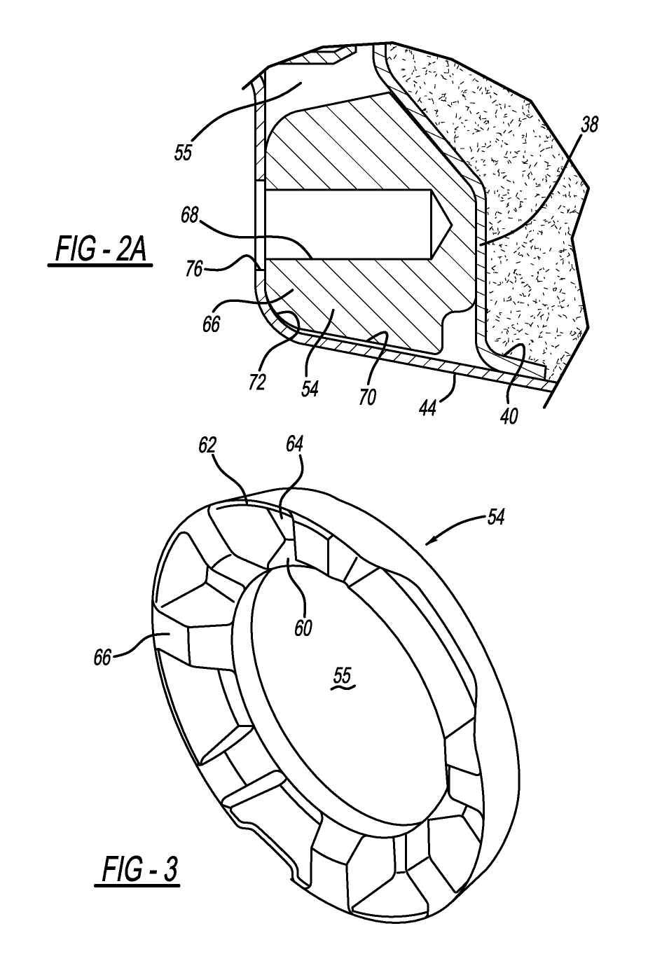

FIGS. 1-2 depict an exemplary exhaust treatment device identified at reference numeral 10. Exhaust treatment device 10 includes a first substrate 12 positioned upstream of a second substrate 14 within a housing 15. First substrate 12 may be a diesel oxidation catalyst or a selective catalytic reduction device, while second substrate 14 may be a diesel particulate filter or a slip catalyst. Other types of exhaust treatment elements, however, may be used in lieu of first substrate 12 and second substrate 14. Additionally, different combinations of substrates 12 and 14 other than those noted above may be used without departing from the scope of the present disclosure. Furthermore, the present disclosure relates to an exhaust treatment device that includes one or more substrates within housing 15. The two substrate arrangements depicted in the Figures is merely for illustration purposes.

Housing 15 includes an inner shell 16 and an outer shell 17 surrounding inner shell 16. Inner shell 16 includes several metal stampings coupled to one another. For example, inner shell 16 includes an inner tube 18 in receipt of first substrate 12 and second substrate 14. The substrates 12, 14 are retained within inner tube 18 using a stuffing or sizing process for compressing a first insulating mat 28 between first substrate 12 and inner tube 18, as well as compressing a second insulating mat 30 between second substrate 14 and inner tube 18. Housing 15 also includes several interconnected stampings such as an outer tube 34 circumscribing inner tube 18. An insulation material 36 surrounds inner tube 18 and is positioned between outer tube 34 and inner tube 18. Insulation material 36 can be any type of insulation material known to one skilled in the art. Insulation material 36 can be a mat-type of insulation material, or be a plurality of loose-fill insulating particles that are fed into gaps between inner housing 16 and outer housing 17.

An inlet assembly 37 is fixed to outer tube 34 and inner tube 18. Inlet assembly 37 includes a ring cover plate 38 (FIG. 2A) having a flange 40 fixed to a first end cap 44. An inner inlet or inner cap 41 includes a lip 43 fixed to inner tube 18. Inner cap 41 forms a portion of inner shell 16 while end cap 44 forms a portion of outer shell 17.

A mounting ring 54 is positioned between first end cap 44 and ring cover plate 38. Mounting ring 54 may be cast from a ductile iron having a high content of silicon and molybdenum as a one-piece monolithic component. This material provides excellent structural physical properties and may withstand the high temperature environment of the exhaust treatment device. The mounting ring may alternatively be formed using processes such as forging, stamping, or machining. Metallic materials other than those listed are also contemplated.

Mounting ring 54 includes a generally cup-shaped hollow cross section defined by an inner wall 60 and an outer wall 62 interconnected by an end wall 64. A plurality of solid mounting bosses 66 are circumferentially spaced apart from one another. Each boss 66 includes a threaded aperture 68 for receipt of a fastener (not shown) to mount exhaust treatment device 10 to the vehicle. To define a robust structural mount for exhaust treatment device 10, an inner surface 70 of first end cap 44 is shaped as a pocket complementing an external surface 72 of mounting ring 54. A plurality of apertures 76 extend through first end cap 44 in alignment with threaded apertures 68. It should be appreciated that mounting ring 54 need not include the cup-shaped portions and may be shaped to have a more consistent solid cross-section.

To account for an inlet pipe assembly 82, mounting ring 54 includes a central aperture 55 that allows inlet pipe assembly 82 to fit therein. Inlet pipe assembly 82 includes a pipe 84 fixed to a shield 86. An insulation material 88 is positioned between pipe 84 and shield 86. Pipe 84 includes a first end 90 extending through both inner housing 16 and outer housing 17 in communication with a cavity 92 formed upstream of first substrate 12. An inlet 94 is formed at the second opposite end of inlet pipe assembly 82 for receipt of exhaust from the internal combustion engine. Although illustrated as being linear, it should be understood that pipe 84 can be elbow-shaped without departing from the scope of the present disclosure.

A flow distribution plate 96 is fixed to inner inlet 41 at a position downstream from first end 90 of pipe 84. Flow distribution plate 96 includes a plurality of spaced apart apertures 98 having different sizes to induce a substantially uniform exhaust gas flow through first substrate 12.

An outlet assembly 100 may be constructed using some of the same or at least very similar components used to manufacture inlet assembly 37. Outlet assembly 100 includes a second end cap 44a, an insulation material 77a, an inner outlet 41a, a pipe 84a, a shield 86a, and an outlet 94a. Other features of outlet assembly 100 are substantially similar to the features of the components forming inlet assembly 37. As such, these elements will be identified with a lower “a” suffix. As illustrated in FIG. 2, inlet assembly 37 and outlet assembly 100 are axially aligned. It should be understood, however, that inlet assembly 37 and outlet assembly 100 are not required to be axially aligned. For example, U.S. patent application Ser. No. 13/268,124 (hereby incorporated by reference in its entirety) is directed to an exhaust treatment device where inlets and outlets thereof are non-axially aligned.

The interconnection of components to form outlet assembly 100 is substantially the same as inlet assembly 37 with the exception that mounting ring 54 is not present within outlet assembly 100 depicted in the Figures. In lieu of a second mounting ring 54, outlet assembly 100 includes a pair of mounting tabs 102 including through-holes 104. Through-holes 104 allow mounting tabs 102 to be either attached to the vehicle using a fastener (not shown), or by using hooks (not shown). Although exhaust treatment device 10 is illustrated as having mounting tabs 102, it should be appreciated, however, that should mounting flexibility be required, outlet assembly 100 may include a mounting ring substantially similar to mounting ring 54. In yet another arrangement, inlet assembly 37 may be constructed without mounting ring 54 and outlet assembly 100 may include a mounting ring sandwiched between second end cap 44a and ring cover plate 38a.

According to the above description, exhaust treatment device 10 is fully insulated from inlet assembly 37 through outlet assembly 100. Full insulation is due to insulations 88, 36, and 77a. Through use of insulations 88, 26, and 77a, exhaust treatment device 10 has increased thermal shielding that prevents heat generated through the exhaust system from being transmitted to the ambient environment in which exhaust treatment device 10 is utilized.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exhaust treatment device, comprising:
a housing including an inner shell and an outer shell;
an insulation material positioned between the inner shell and the outer shell;
at least one substrate for treating an exhaust gas positioned within the housing; and
an insulating mat disposed between the substrate and the inner shell.

2. The exhaust treatment device of claim 1, further comprising a second substrate coaxially aligned with the substrate and positioned within the housing.

3. The exhaust treatment device of claim 2, wherein a second insulating mat is disposed between the second substrate and the inner shell.

4. The exhaust treatment device of claim 1, further comprising an inlet assembly coupled to the housing, the inlet assembly including an inner inlet attached to the inner shell, and an inlet end cap spaced apart from the inner inlet attached to the outer shell.

5. The exhaust treatment device of claim 4, further comprising the insulation material disposed between the inner inlet and the inlet end cap.

6. The exhaust treatment device of claim 4, further comprising an outlet assembly coupled to the housing, the outlet assembly including an inner outlet attached to the inner shell, and an outlet end cap spaced apart from the inner outlet attached to the outer shell.

7. The exhaust treatment device of claim 6, further comprising the insulating material disposed between the inner outlet and the outlet end cap.

8. The exhaust treatment device of claim 4, further comprising a flow distribution device upstream of the substrate in the inlet assembly.

9. The exhaust treatment device of claim 4, wherein the inlet assembly further comprises an inlet pipe assembly including a pipe spaced apart from a shield, with the insulation material disposed between the pipe and the shield.

10. The exhaust treatment device of claim 6, wherein the inlet assembly and the outlet assembly are axially aligned.

11. The exhaust treatment device of claim 6, wherein the outlet assembly further comprising an outlet pipe assembly including an outlet pipe spaced apart from an outlet shield, with the insulation material disposed between the outlet pipe and the outlet shield.

12. The exhaust treatment device of claim 6, further comprising a mounting ring disposed at one of the inlet assembly and the outlet assembly.

13. An exhaust treatment device, comprising:
a housing including an inner shell and an outer shell spaced apart by a first gap;
an inlet assembly including a first inner cap and a first outer cap spaced apart by a second gap;
an outlet assembly including an second inner cap and a second outer cap spaced apart from each other by a third gap;
at least one exhaust treatment substrate disposed between the inlet assembly and the outlet assembly, the at least one exhaust treatment substrate located within the housing; and
an insulating mat disposed between the exhaust treatment substrate and the inner shell,
wherein each of the first, second, and third gaps are in communication with each other, and filled with an insulation material.

14. The exhaust treatment device of claim 13, further comprising a flow distribution plate positioned upstream of the exhaust treatment substrate.

15. The exhaust treatment device of claim 13, wherein the exhaust treatment substrate is one selected from the group consisting of an oxidation catalyst, a selective catalytic reduction catalyst, a particulate filter, and a slip catalyst.

16. The exhaust treatment device of claim 13, further comprising a mounting ring disposed at one of the inlet assembly and the outlet assembly.

17. The exhaust treatment device of claim 13, wherein the insulation material is a loose-fill insulation material.

18. The exhaust treatment device of claim 16, wherein the mounting ring is formed from a ductile iron alloy.

19. The exhaust treatment device of claim 16, wherein the mounting ring is fixed to the outer shell.

20. The exhaust treatment device of claim 14, wherein the flow distribution plate includes a plurality of apertures positioned such that the exhaust passes through the apertures prior to entering the substrate.
